(19) United States
(12) Patent Application Publication
(10) Pub. No.: US 2014/0185727 A1
(43) Pub. Date: Jul. 3, 2014

(54) POWER MONITORING SYSTEM FOR A NUCLEAR REACTOR

(71) Applicant: Kabushiki Kaisha Toshiba, Minato-ku (JP)

(72) Inventors: Teruji TARUMI, Tokyo (JP); Takayoshi FURUSAWA, Tokyo (JP); Tadashi MIYAZAKI, Kanagawa-ken (JP)

(73) Assignee: Kabushiki Kaisha Toshiba, Minato-ku (JP)

(21) Appl. No.: 14/140,846

(22) Filed: Dec. 26, 2013

(30) Foreign Application Priority Data
Dec. 26, 2012 (JP) 2012-282496

(51) Int. Cl. G21C 17/02

(52) U.S. Cl. CPC G21C 17/02
USPC 376/246

(57) ABSTRACT

According to an embodiment, a power monitoring system for a nuclear reactor comprises at least a first system and second system. The first system and the second system respectively comprise a plurality of APRM units, a plurality of FLOW units, and a plurality of OPRM units. The APRM units respectively generate an LPRM signal that indicates the local output of neutrons by the reactor core, and generate an APRM signal indicating the average output of the reactor core, based on the LPRM signal. The FLOW units respectively generate a FLOW signal indicating the flow rate of reactor coolant. The OPRM units respectively are supplied with the LPRM signal and the APRM signal from at least two aforementioned APRM units and are supplied with the FLOW signal from at least one aforementioned FLOW unit; and, based on the supplied LPRM signals, APRM signals and FLOW signals, generate a trip signal for shutting down the reactor.

### CROSS REFERENCE TO RELATED APPLICATION

This application claims benefit of priority to Japanese Application No. JP2012-282496 filed Dec. 26, 2012; the entire contents of which are incorporated by reference herein.

### FIELD

Embodiments described herein relate generally to a power monitoring system for a nuclear reactor (hereinafter sometimes for the convenience referred to as power monitoring system).

### BACKGROUND

In a boiling water reactor, there is repeated lowering of output due to generation of voids and elevation of output due to disappearance of voids; and it is possible for output oscillations to be generated in which the reactor output oscillates with increasing amplitude. If such output oscillation is detected, it is therefore necessary for a trip signal to be generated to shut down (SCRAM) the reactor. In order to generate the trip signal, signals generated by units called APRM units (to be later described) and/or FLOW units (to be later described) are employed.

Examples of such units are disclosed in U.S. Pat. No. 5,174,946 (hereinafter referred to as patent reference 1).

The aforementioned units do not necessarily always operate normally, and so may be disabled for maintenance or due to malfunction. There is the problem that, if the units are disabled, it is difficult to protect the reactor in a reliable fashion, because the trip signal cannot be generated.

An object of the present invention is therefore to provide a power monitoring system whereby the reactor can be appropriately shut down.

In order to achieve the above object, an embodiment of the present invention comprises the following construction. Specifically, there is provided:

a power monitoring system for a nuclear reactor, having at least a first system and second system, the first system and the second system respectively comprising:

a plurality of APRM units;

a plurality of FLOW units; and

a plurality of OPRM units;

wherein:

the APRM units respectively generate an LPRM signal that indicates the local output of neutrons by the reactor core, and generate an APRM signal indicating the average output of the reactor core, based on the LPRM signal;

the FLOW units respectively generate a FLOW signal indicating the flow rate of reactor coolant; and

the OPRM units respectively are supplied with LPRM signals and APRM signals from at least two the APRM units and are supplied with the FLOW signal from at least one the FLOW unit; and, based on the supplied LPRM signals, APRM signals and FLOW signals, decide whether or not a trip signal for shutting down the reactor is to be generated and, if they decide that such the signal is to be generated, generate the trip signal.

Furthermore, an embodiment of the present invention is constructed as follows. Specifically, there is provided:

a power monitoring system for a nuclear reactor, having at least a first system and second system, the first system and the second system respectively comprising:

a plurality of APRM units;

at least one FLOW unit; and

a plurality of OPRM units;

wherein:

the APRM units respectively generate an LPRM signal that indicates the local output of neutrons by the reactor core, and generate an APRM signal indicating the average output of the reactor core, based on the LPRM signal;

the FLOW units respectively generate a FLOW signal indicating the flow rate of reactor coolant; and

the OPRM units respectively are supplied with LPRM signals and APRM signals from at least two the APRM units in the same system and are supplied with the FLOW signal from at least one of the FLOW unit in the same system and the FLOW unit in the other system; and, based on the supplied LPRM signals, APRM signals and FLOW signals, decide whether or not a trip signal for shutting down the reactor is to be generated and, if they decide that such the signal is to be generated, generate the trip signal.

### BRIEF DESCRIPTION OF THE DRAWINGS

FIG. 1 is a block diagram showing the diagrammatic layout of a power monitoring system for a reactor according to a first embodiment;

FIG. 2 is a view showing the source of supply of the signals that are supplied to each OPRM unit;

FIG. 3 is a block diagram showing the diagrammatic layout of a power monitoring system for a reactor according to a second embodiment;

FIG. 4 is a view showing the source of supply of the signals that are supplied to each OPRM unit;

FIG. 5 is a block diagram showing the diagrammatic layout of a power monitoring system for a reactor according to a third embodiment;

FIG. 6 is a view showing the source of supply of the signals supplied to each OPRM unit;

FIG. 7 is a block diagram showing the diagrammatic layout of a power monitoring system for a reactor according to a fourth embodiment;

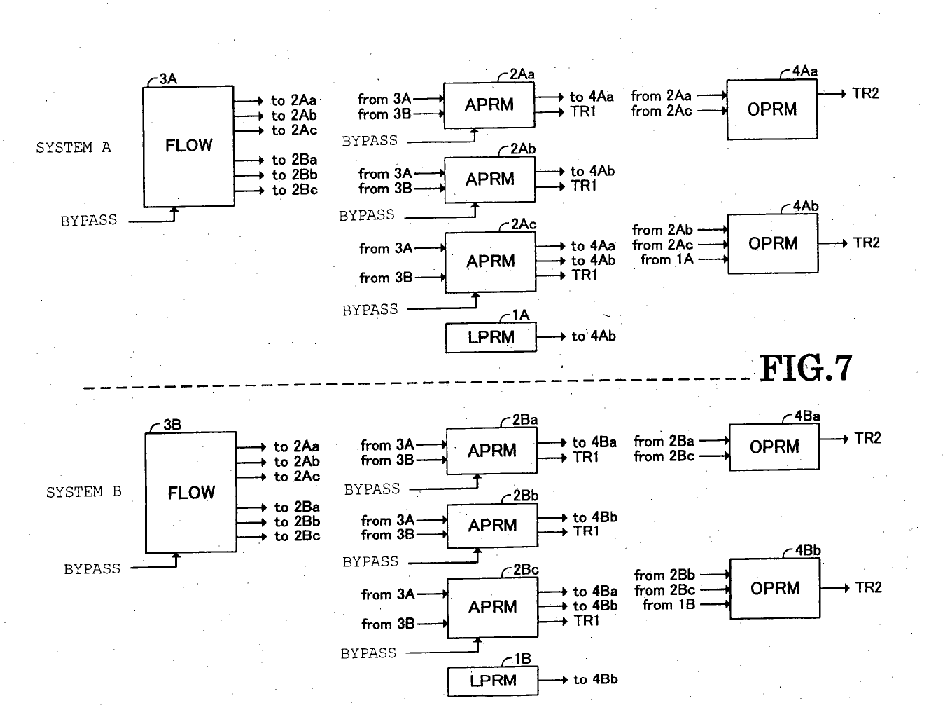

FIG. 8 is a view showing the source of supply of the signals supplied to each OPRM unit;

FIG. 9 is a block diagram showing the diagrammatic layout of a power monitoring system for a reactor according to a fifth embodiment; and

FIG. 10 is a view showing the source of supply of the signals supplied to each OPRM unit.

### DETAILED DESCRIPTION

A detailed description of the embodiments is given below with reference to the drawings.

### First Embodiment

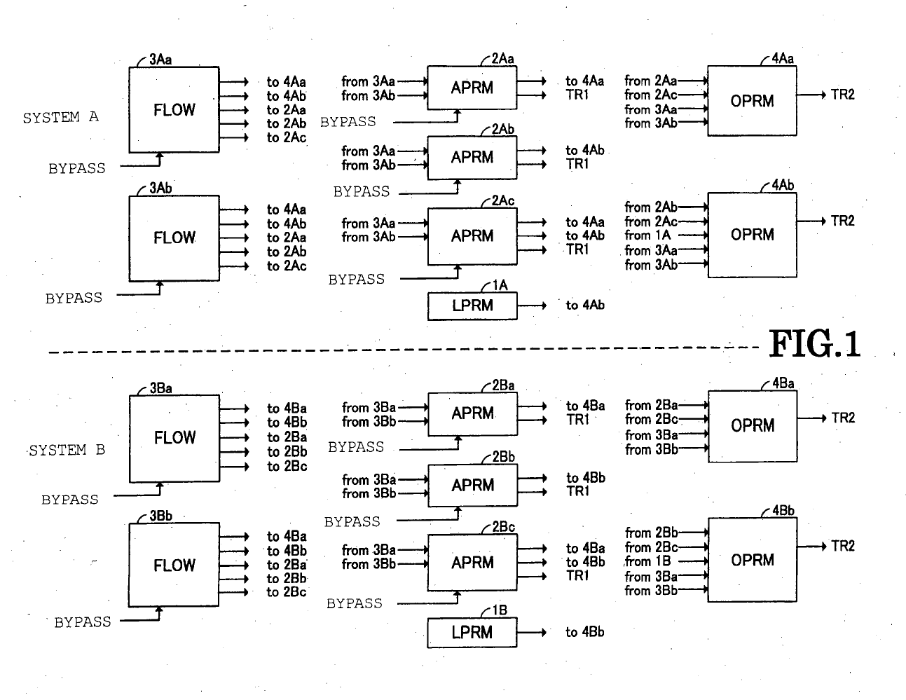

FIG. 1 is a block diagram showing the diagrammatic layout of the power monitoring system of a boiling water reactor (hereinafter simply referred to as a reactor) according to a first embodiment. This power monitoring system is constituted of two systems, namely, a system A and a system B. The reactor can be safely protected so long as at least one of system A and system B is operating normally, in other words, even if, for example, it is supposed that one of these has failed.

The power monitoring system A comprises: a single local output monitoring device (Local Power Range Monitor, hereinafter abbreviated as LPRM unit) 1A; three average output monitoring devices (Average Power Range Monitor: hereinafter abbreviated as APRM unit) 2Aa to 2Ac; two flow rate monitoring devices (hereinafter called FLOW units) 3Aa, 3Ab; and two output oscillation monitoring devices (Oscillation Power Range Monitor, hereinafter called OPRM units) 4Aa, 4Ab.

Likewise, the power monitoring system B comprises: one LPRM unit 1B; three APRM units 2Ba to 2Bc; two FLOW units 3Ba, 3Bb; and two OPRM units 4Ba, 4Bb.

In this embodiment, system A and system B are of the same construction, so the description will focus hereinafter on system A.

The LPRM unit 1A generates an LPRM signal that indicates the local output of neutrons by the reactor core. The function of generating an LPRM signal is called a local output monitoring function.

The APRM units 2Aa to 2Ac, in addition to generating an LPRM signal, generate an APRM signal that indicates the average output of the reactor core as a whole, based on these LPRM signals that are thus generated. The function of generating an APRM signal is called an average output monitoring function. Also, the APRM units 2Aa to 2Ac have a self-diagnostic function whereby an APRM unit can detect a fault in the APRM unit in question and arrange for this APRM unit to be bypassed (to be later described), and generate diagnostic information indicating whether or not the APRM unit in question itself is operating normally.

The LPRM units and APRM units may also be referred to in general as monitoring units.

The FLOW units 3Aa, 3Ab calculate the flow rate of the reactor coolant and generate a FLOW signal indicating this flow rate. Also, the FLOW units 3Aa, 3Ab have a self-diagnostic function whereby an FLOW unit can detect a fault in the FLOW unit in question and arrange for this FLOW unit to be bypassed (to be later described), and generate diagnostic information indicating whether or not the FLOW unit in question itself is operating normally.

The OPRM unit 4Aa, 4Ab uses the LPRM signal, APRM signal and FLOW signal to monitor for output oscillation of the reactor core.

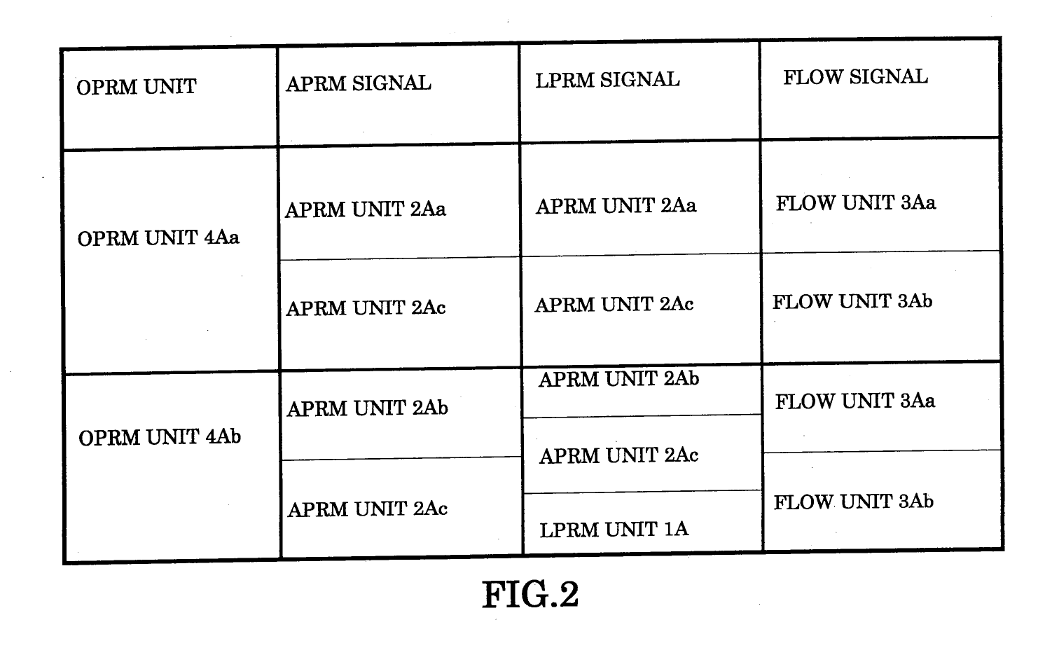

FIG. 2 is a view showing the source of supply of the signals supplied to each OPRM unit. As shown in this Figure, the OPRM unit 4Aa receives APRM signals from the APRM units 2Aa, 2Ac, receives LPRM signals from the APRM units 2Aa, 2Ac, and receives FLOW signals from the FLOW units 3Aa, 3Ab. Also, the OPRM unit 4Ab receives APRM signals from the APRM units 2Aa, 2Ac, receives LPRM signals from the APRM units 2Aa, 2Ac, receives an LPRM signal from the LPRM unit 1A, and receives FLOW signals from the FLOW units 3Aa, 3Ab.

Next, a more specific description will be given concerning the LPRM unit 1A and the APRM units 2Aa, 2Ac.

Let us assume that the reactor of this embodiment comprises 764 fuel assemblies. In order to detect the local distribution neutrons in the reactor, 43 local output region monitoring detector assemblies (not shown. Hereinafter referred to as LPRM strings) are arranged within the reactor core. Each LPRM string incorporates four LPRM detectors. In other words, a total of 172 LPRM detectors are provided.

The neutron signals that are output from these LPRM detectors are distributed to eight monitoring units (specifically, one LPRM unit 1A and three APRM units 2Aa to 2Ac within system A, and one LPRM unit 1B and three APRM units 2Ba to 2Bc within system B).

When a monitoring unit receives a neutron signal, it generates an LPRM signal indicating the respective local outputs at the positions of the detectors. Of the eight monitoring units, the six APRM units 2Aa to 2Ac and 2Ba to 2Bc average the values indicating the LPRM signals calculated by the device in question and generate an APRM signal indicating the average output of the entire reactor core.

It should be noted that, since the LPRM signals indicate local outputs within the reactor core, these signals may be mutually different depending on the position of the LPRM detector in question.

In contrast, the APRM signal is an average value, so the APRM signals that are generated by all of the APRM units show substantially the same value.

When the APRM units detect abnormal elevation of the value of the APRM signal, they transmit a first trip signal TR1 to the reactor protection system (hereinafter abbreviated as RPS). The reactor is shut down in response to this first trip signal TR1. The threshold value at which this first trip signal TR1 is delivered is set based on the FLOW signals generated by the FLOW units.

Next, a detailed description of the FLOW units will be given.

The FLOW units 3Aa, 3Ab receive signals from differential pressure transmitters arranged in each recirculation loop of the reactor. The FLOW units 3Aa, 3Ab convert the signals from the differential pressure transmitters to flow rate signals indicating the flow rate of coolant. In addition, based on the flow rate signals, the FLOW units 3Aa, 3Ab calculate the total of the coolant flow rates in the recirculation loops and generate flow rate signals (i.e. FLOW signals) by standardizing these flow rate signals, using the prescribed reactor flow rate.

These FLOW signals are supplied to the APRM units 2Aa to 2Ac and employed in setting the threshold value for delivering the first trip signal TR1. Also, the FLOW signals are supplied to the OPRM units 4Aa, 4Ab.

Next, a more specific description will be given concerning the OPRM units 4Aa, 4Ab.

The OPRM units 4Aa, 4Ab receive mutually different LPRM signals from the LPRM unit 1A and/or the APRM units 2Aa to 2Ac. In the example of FIG. 1 and FIG. 2, the OPRM unit 4Aa receives a total of two LPRM signals from the APRM units 2Aa, 2Ac; and the LPRM unit 4Ab receives a total of three LPRM signals from the LPRM unit 1A and APRM units 2Ab, 2Ac.

Next, the OPRM units 4Aa, 4Ab collect these LPRM signals into group units called OPRM cells and average and standardize these LPRM signals, thereby generating a plurality of OPRM cell signals. The OPRM units 4Aa, 4Ab monitor fluctuations of the values of each of the OPRM cell signals and, if output fluctuation of at least one of the values of these OPRM cell signals is detected, the OPRM units 4Aa, 4Ab generate a second trip signal TR2 and transmit this to the RPS. This is in order to prevent oscillations in the reactor output increasing in an amplified fashion. The reactor is shut down in response to the second trip signal TR2.

However, if the reactor output is very low or if the reactor coolant flow rate is very high, it is difficult to conceive that there could be oscillations in the reactor output increasing in an amplified fashion. The OPRM units 4Aa, 4Ab therefore take into consideration the value of the APRM signal indicating the reactor output (or signal simulating the reactor heat output based on the APRM signal) and the value of the FLOW signal indicating the reactor coolant flow rate, in deciding whether or not to deliver the second trip signal TR2.

For this purpose, the OPRM unit 4Aa receives the APRM signals from the APRM units 2Aa, 2Ac and receives the FLOW signals from the FLOW units 3Aa, 3Ab. Also, the OPRM unit 4Ab receives the APRM signals from the APRM units 2Ab, 2Ac and receives the FLOW signals from the FLOW units 3Aa, 3Ab.

Also, when the OPRM units 4Aa, 4Ab, based on the APRM signal, determine that “reactor output is high” and when they determine, based on the FLOW signal, that “reactor coolant flow rate is low”, if output fluctuations in the value of the OPRM cell signal are detected, a second trip signal TR2 is generated and transmitted to the RPS. In other words, if the reactor output is lower than a prescribed threshold value and if the reactor coolant flow rate is higher than a prescribed threshold value, the second trip signal TR2 is not generated.

This embodiment relates in particular to the generation of the second trip signal TR2.

It should be noted that, in order to prevent propagation of the electrical faults between units, it is desirable to make all signals digital signals and carry out electrical-optical conversion, optical signal transmission being performed between the units using optical fiber cable.

In this connection it may be mentioned that the APRM units 2Aa to 2Ac may not necessarily always operate correctly. For example, the APRM units 2Aa to 2Ac may fail, or may be disabled for maintenance. In the case of maintenance, it is necessary to bypass the APRM unit.

For this purpose, an APRM bypass switch (not shown) is provided in the power monitoring system. Thus bypassing can be achieved by selecting a single APRM unit of the system A and/or a single APRM unit of the system B. The first trip signal TR1 is not transmitted in order to ensure that there is no possibility that input of the bypass signal to the selected APRM unit could affect the RPS. Also, the selected APRM unit does not generate the normal APRM signal or LPRM signal.

In this embodiment, compared with the two OPRM units 4Aa, 4Ab of system A, there are provided three APRM units 2Aa to 2Ac i.e. one more than this. A characteristic feature of this embodiment, as referred to above, is that the OPRM unit 4Aa receives LPRM signals from two APRM units 2Aa, 2Ac, while the OPRM unit 4Ab receives LPRM signals from the LPRM unit 1A and the two APRM units 2Ab, 2Ac. In other words, a single OPRM unit receives a plurality of LPRM signals.

Consequently, even when a single APRM unit is bypassed, the OPRM units 4Aa, 4Ab can generate OPRM cell signals from the LPRM signals from the other APRM unit or LPRM unit 1A.

For example, even when the APRM unit 2Aa is bypassed (here and hereinafter, including the cases where it is not operating normally due for example to a malfunction), the OPRM unit 4Aa can generate an OPRM cell signal based on the LPRM signal from the APRM unit 2Ac. Also, even when the APRM unit 2Ab is bypassed, the OPRM unit 4Ab can generate an OPRM cell signal based on the LPRM signal from the APRM unit 1A. Furthermore, even when the APRM unit 2Ac is bypassed, the OPRM unit 4Aa can generate an OPRM cell signal based on the APRM unit 2Aa and the OPRM unit 4Ab can generate an OPRM cell signal based on the LPRM signal from the APRM unit 2Ab or the LPRM unit 1A.

In this way, even if one APRM unit is bypassed, the OPRM units 4Aa, 4Ab generate OPRM cell signals correctly, which can be used to detect output oscillations.

Also, in addition to the APRM signals, the APRM units 2Aa to 2Ac supply the aforementioned diagnostic information to the OPRM unit. Also, as one of the characteristic features of this embodiment, the OPRM unit 4Aa receives the APRM signal and the diagnostic information of the APRM unit in question itself from the two APRM units 2Aa, 2Ac and the OPRM unit 4Ab receives the APRM signal and the diagnostic information of the APRM unit in question itself from the two APRM units 2Ab, 2Ac. In other words a single OPRM unit receives two APRM signals.

If the OPRM units 4Aa, 4Ab indicate that the diagnostic information accompanying the two received APRM signals is in each case normal, they decide whether or not the reactor output is high, based on whichever of these two APRM signals has the larger value.

In contrast, if it is indicated that one of the diagnostic information items associated with the two APRM signals received by the OPRM units 4Aa, 4Ab is abnormal, the OPRM units 4Aa, 4Ab determine whether or not the reactor output is high based on the APRM signal supplied from the APRM unit indicating that the unit in question is normal.

In this way, even if one of the APRM units is bypassed, the OPRM units 4Aa, 4Ab can correctly determine whether or not the reactor output is high and can use this determination to generate a second trip signal TR2.

It should be noted that, in the case where neither of the diagnostic information items associated with the received two APRM signals is normal, the OPRM units 4Aa, 4Ab cannot make a determination and so, with a view to safety, would generate the second trip signal TR2.

Also, the FLOW units 3Aa, 3Ab may also not necessarily always operate correctly. A FLOW bypass switch (not shown) is therefore provided in the power monitoring system. Thus bypassing can be effected selecting one of the FLOW units of the system A and/or one of the FLOW units of the system B. The selected FLOW unit does not generate a normal FLOW signal.

In this embodiment, two FLOW units 3Aa, 3Ab are provided in the system A. These FLOW units 3Aa, 3Ab supply diagnostic information and FLOW signals to the two OPRM units 4Aa, 4Ab. In other words, the OPRM units 4Aa, 4Ab receive FLOW signals and diagnostic information from the two FLOW units 3Aa, 3Ab.

If the diagnostic information associated with the two FLOW signals received by the OPRM units 4Aa, 4Ab indicates that both of these FLOW units are normal, a determination as to whether or not the reactor coolant flow rate is low is made based on the FLOW signal which has the smallest value of these two FLOW signals.

On the other hand, if one of the items of diagnostic information associated with the two FLOW signals that have been received by the OPRM units 4Aa, 4Ab is abnormal, a decision as to whether or not the reactor coolant flow rate is low is made based on the FLOW signal supplied from the FLOW unit that indicates that the FLOW unit in question is normal.

In this way, even if one FLOW unit is bypassed, the OPRM units 4Aa, 4Ab can correctly determine whether or not the reactor coolant flow rate is low, and use the result of this determination to generate the second trip signal TR2.

It should be noted that, in the case where neither of the diagnostic information items associated with the received two FLOW signals is normal, the OPRM units 4Aa, 4Ab cannot make a determination and so, with a view to safety, would generate the second trip signal TR2.

As described above, even in the case where one of the APRM units, or one of the FLOW units, is not operating normally because of malfunction or bypassing, the OPRM units can receive a correct APRM signal, LPRM signal and FLOW signal, and so can use these to generate the second trip signal TR2.

Thus, in the first embodiment, a single OPRM unit is supplied with a plurality of APRM signals and a plurality of FLOW signals. Consequently, even if one of the APRM units or one of the FLOW units is not operating normally, the OPRM functionality is maintained, and a trip signal can be generated in an appropriate fashion.

In other words, even if bypassing of an APRM unit or FLOW unit is performed during reactor operation, the OPRM functionality is not lost and safe functioning is maintained. Consequently, when bypassing an APRM unit or FLOW unit, there is no need to bypass the OPRM unit. As a result, the load on the staff monitoring the OPRM units can be decreased.

### Second Embodiment

In the first embodiment described above, the FLOW signal was directly supplied from the FLOW units 3Aa, 3Ab to the OPRM units 4Aa, 4Ab. In contrast, in the second embodiment described below, the FLOW signal is supplied from the FLOW unit to the OPRM unit through an APRM unit.

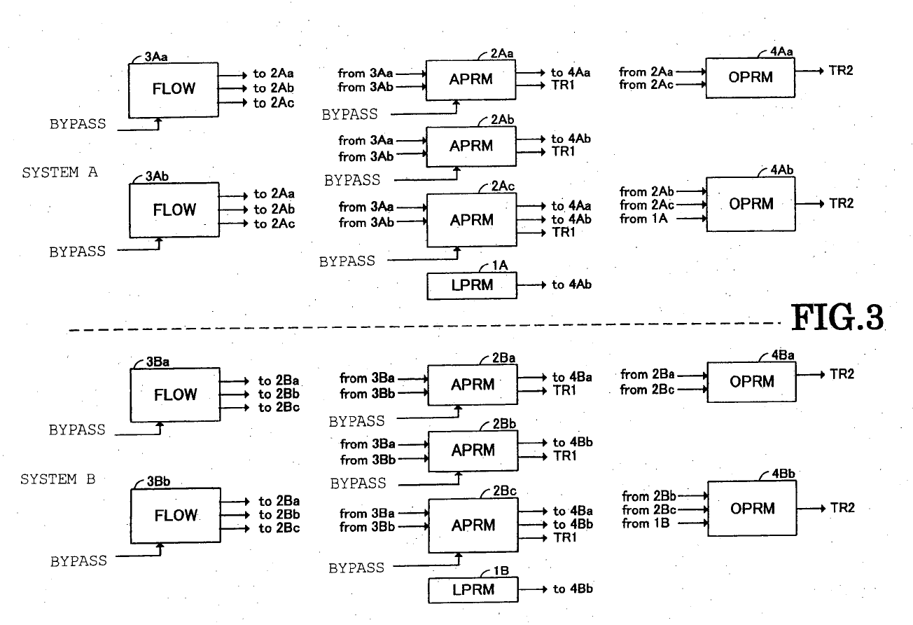

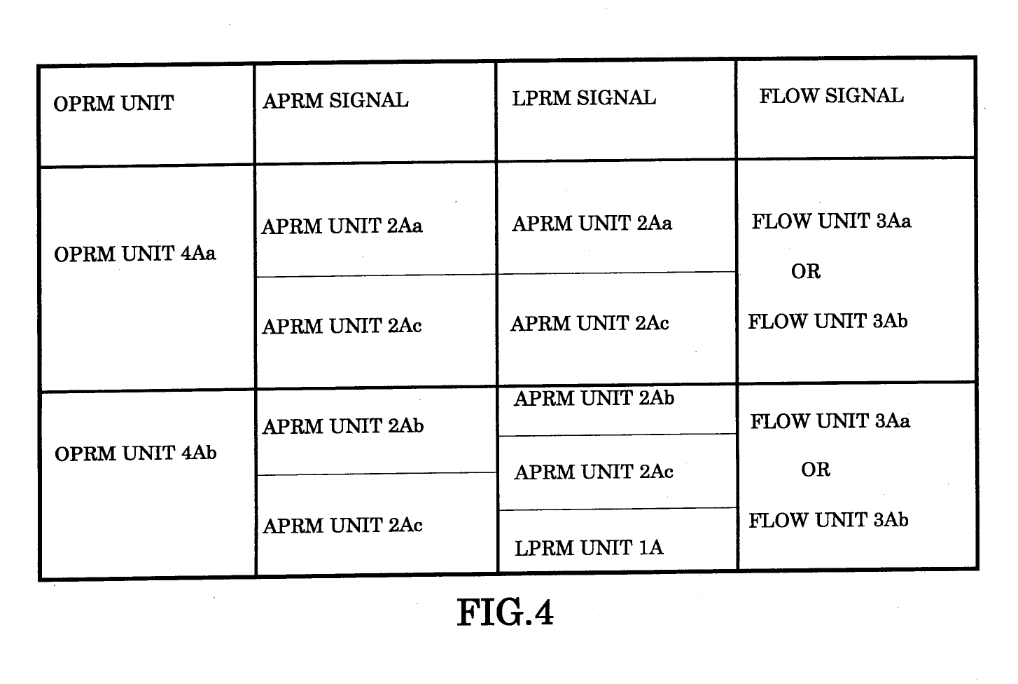

FIG. 3 is a block diagram showing the diagrammatic layout of an power monitoring system of a reactor according to the second embodiment. FIG. 4 is a view showing the sources of supply of the signals that are supplied to each OPRM unit. Hereinafter, the description will focus on the differences from the first embodiment.

The FLOW units 3Aa, 3Ab supply FLOW signals and diagnostic information to the APRM units 2Aa to 2Ac.

If the diagnostic information associated with the two FLOW signals received by the APRM unit 2Aa indicates normality in both cases, the FLOW signal, of these two FLOW signals, whose value is smallest, is supplied to the OPRM unit 4Aa.

In contrast, if one of the items of diagnostic information associated with the two received FLOW signals received by the APRM unit 2Aa is abnormal, the FLOW signal that is supplied from the FLOW unit that indicates that the FLOW unit in question is normal is supplied to the OPRM unit 4Aa.

If the diagnostic information associated with the two received FLOW signals indicates abnormality in both cases, the APRM unit 2Aa would supply to the OPRM unit 4Aa a message indicating inability to determine the reactor coolant flow rate.

The processing operation of the APRM units 2Ab, 2Ac is just the same as that of the APRM unit 2Aa, apart from the fact that the signal supply destination of the APRM unit 2Ab is the OPRM unit 4Ab, and the signal supply destination of the APRM unit 2Ac is the OPRM units 4Aa, 4Ab.

In FIG. 4 relating to the present embodiment, the supply source of the FLOW signal in FIG. 2 in the first embodiment is somewhat different. Specifically, the OPRM units 4Aa, 4Ab receive one of the FLOW signals generated by the FLOW units 3Aa, 3Ab; specifically, they receive whichever signal is normal or whose value is smallest. However, the supply of FLOW signals from the plurality of APRM units to the OPRM unit is in itself the same as in the first embodiment. Other details are the same as in FIG. 2, so a detailed description thereof is dispensed with.

As a result, the OPRM unit 4Aa receives from the APRM unit 2Aa an APRM signal, diagnostic information, an LPRM signal and a single FLOW signal (or information to the effect that the reactor coolant flow rate cannot be determined), and also receives from the APRM unit 2Ac an APRM signal, diagnostic information, an LPRM signal and a single FLOW signal (or information to the effect that the reactor coolant flow rate cannot be determined). The same applies to the OPRM unit 4Ab.

If the OPRM units 4Aa, 4Ab receive a message to the effect that the reactor coolant flow rate cannot be determined, for safety reasons, they generate the second trip signal and transmit this to the RPS. If no such message to the effect that the reactor coolant flow rate cannot be determined is received, the following procedure is adopted.

If the diagnostic information associated with the two received APRM signals indicates normality in both cases, the OPRM units 4Aa, 4Ab determine whether or not the reactor output is high, based on the APRM signal that has the largest value, of these two APRM signals, and determine whether or not the reactor coolant flow rate is low, based on the FLOW signal.

In contrast, if one or other of the items of diagnostic information associated with the two received APRM signals indicates abnormality, the OPRM units 4Aa, 4Ab cannot use the APRM signal or FLOW signal supplied from this abnormal APRM unit. Accordingly, the OPRM units 4Aa, 4Ab determine whether or not the reactor output is high based on the APRM signal and determine whether or not the reactor coolant flow rate is low based on the FLOW signal, these signals being supplied from the other APRM unit, which is normal.

It should be noted that if neither of the diagnostic signals associated with the two received APRM signals indicates normality, the OPRM units 4Aa, 4Ab conclude that determination is impossible and, for safety reasons, generate the second trip signal TR2 and transmit this signal to the RPS.

In this way, in this second embodiment, just as in the case of the first embodiment, even if one of the APRM units or one of the FLOW units is not operating normally, the OPRM functionality is maintained and a trip signal can be appropriately generated. Furthermore, in this second embodiment, by supplying the FLOW signal from the FLOW unit to the OPRM unit via the APRM unit, the FLOW signal can be shared by the OPRM unit and APRM unit. There is therefore no need to increase communication links between the FLOW unit and the OPRM unit, so the number of wirings can be reduced, simplifying the hardware construction.

### Third Embodiment

In the case of the first and second embodiments described above, the system A and system B were respectively provided with two FLOW units. In contrast, in the third embodiment described below, the system A and system B are respectively provided with a single FLOW unit.

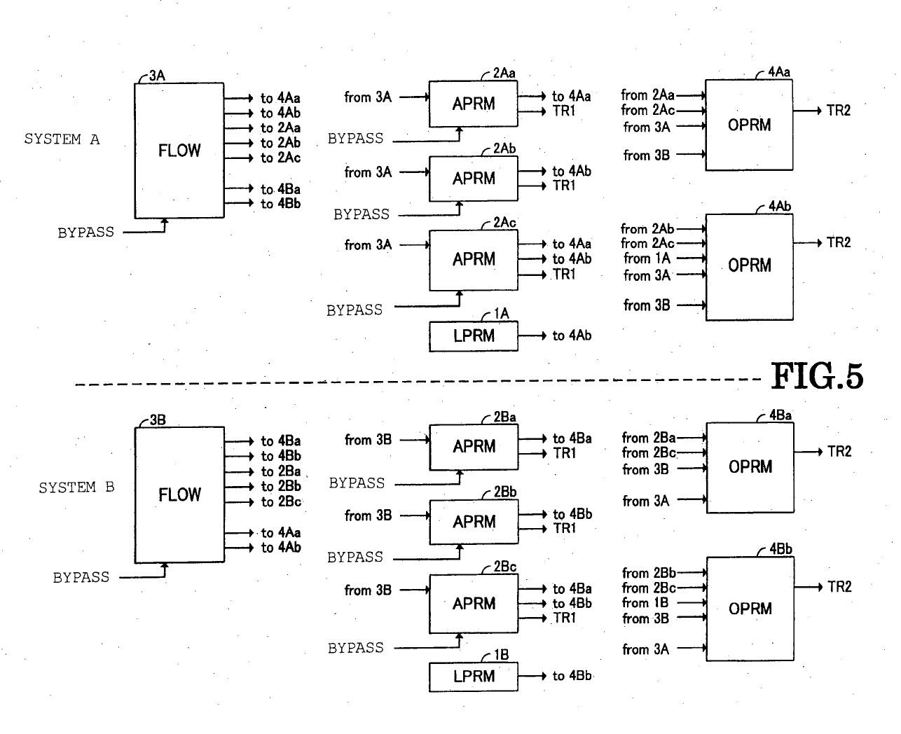

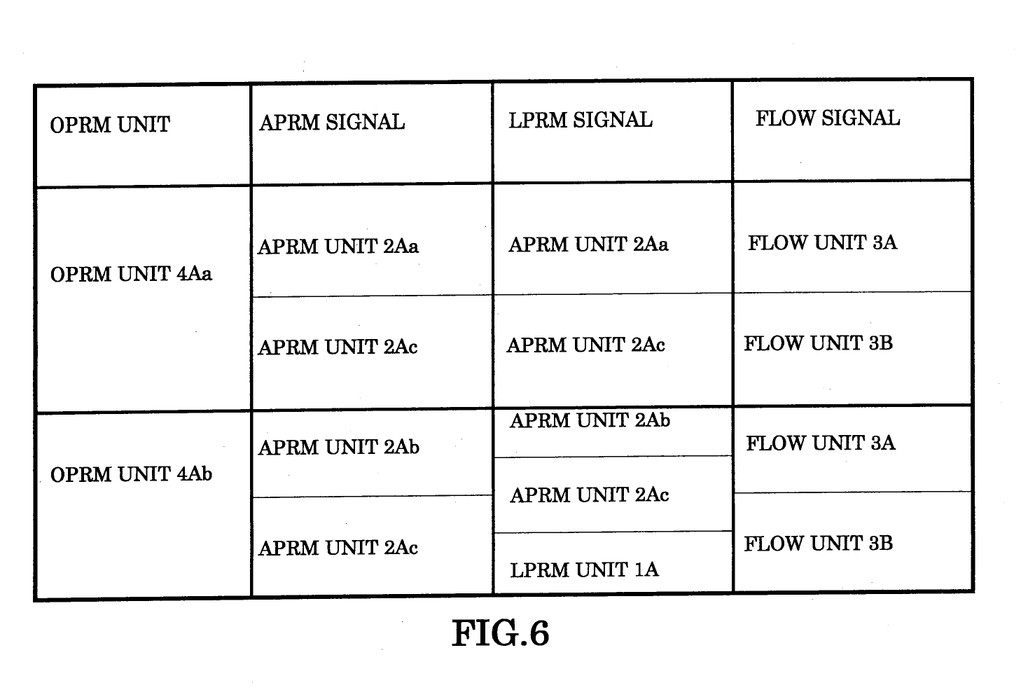

FIG. 5 is a block diagram showing the diagrammatic layout of a power monitoring system for a reactor according to the third embodiment. Also, FIG. 6 shows the source of supply of the signals that are supplied to each OPRM unit. The description below will focus on the differences with regard to the first embodiment.

In this embodiment, the power monitoring system A comprises a single FLOW unit 3A. The FLOW unit 3A supplies a FLOW signal not only to the OPRM units 4Aa, 4Ab but also to the OPRM units 4Ba, 4Bb of the system B. Likewise, the power monitoring system B comprises a single FLOW unit 3B. The FLOW unit 3B supplies a FLOW signal not only to the OPRM units 4Ba, 4Bb but also to the OPRM units 4Aa, 4Ab of system A.

Accordingly, in this embodiment also, a single OPRM unit receives FLOW signals from two FLOW units 3A, 3B. It is desirable to employ optical fiber cables in order to electrically isolate the system A and the system B when FLOW signals are transmitted from the system A to the system B or from the system B to the system A. Of course, optical fiber cables may also be employed for single transmission within the system A and within the system B.

In this embodiment also, just as in the first embodiment, one of the APRM units 2Aa to 2Ac of the system A can be bypassed.

Also, in this embodiment, even though the system A and system B respectively possess only a single FLOW unit each, either of these can be bypassed.

Specifically, if both of the items of diagnostic information associated with the two FLOW signals received indicate normality, the OPRM units 4Aa, 4Ab determine whether or not the reactor coolant flow rate is low based on the FLOW signal of smallest value, of the two FLOW signals.

On the other hand, if one of the items of diagnostic information associated with the two received FLOW signals indicates abnormality, the OPRM units 4Aa, 4Ab determine whether or not the reactor coolant flow rate is low based on the FLOW signal that is supplied from the FLOW unit that this indicates that FLOW unit is normal.

Thus, even if one of the FLOW units is bypassed, the OPRM units 4Aa, 4Ab can correctly determine whether or not the reactor coolant flow rate is low, and can use this determination to generate the second trip signal TR2.

It should be noted that, in the case where neither of the diagnostic information items associated with the received two FLOW signals is normal, the OPRM units 4Aa, 4Ab cannot make a determination and so, with a view to safety, would generate the second trip signal TR2 and supply this to the RPS.

Thus, in this third embodiment, just as in the case of the first embodiment, even if one of the APRM units is not operating normally, the OPRM functionality is maintained and a trip signal can be generated in an appropriate manner. Furthermore, in this third embodiment, the FLOW signal is supplied from the FLOW unit 3A of system A and to the OPRM units 4Ba, 4Bb of system B and the FLOW signal is supplied from the FLOW unit 3B of system B to the OPRM units 4Aa, 4Ab of system A. Consequently, in a power monitoring system in which only a single FLOW unit is provided in each system, even in the case where the FLOW unit in one system is not operating normally, the OPRM functionality can be maintained by utilizing the FLOW unit of the other system and the trip signal can be generated in an appropriate fashion.

### Fourth Embodiment

In the third embodiment described above, the FLOW signal was supplied directly from the FLOW units 3A, 3B to the OPRM units 4Aa, 4Ab and 4Ba, 4Bb. In contrast, in the fourth embodiment described below, the FLOW signal is supplied from the FLOW unit to the OPRM unit through an APRM unit. Specifically, the construction of the second embodiment is applied to the third embodiment.

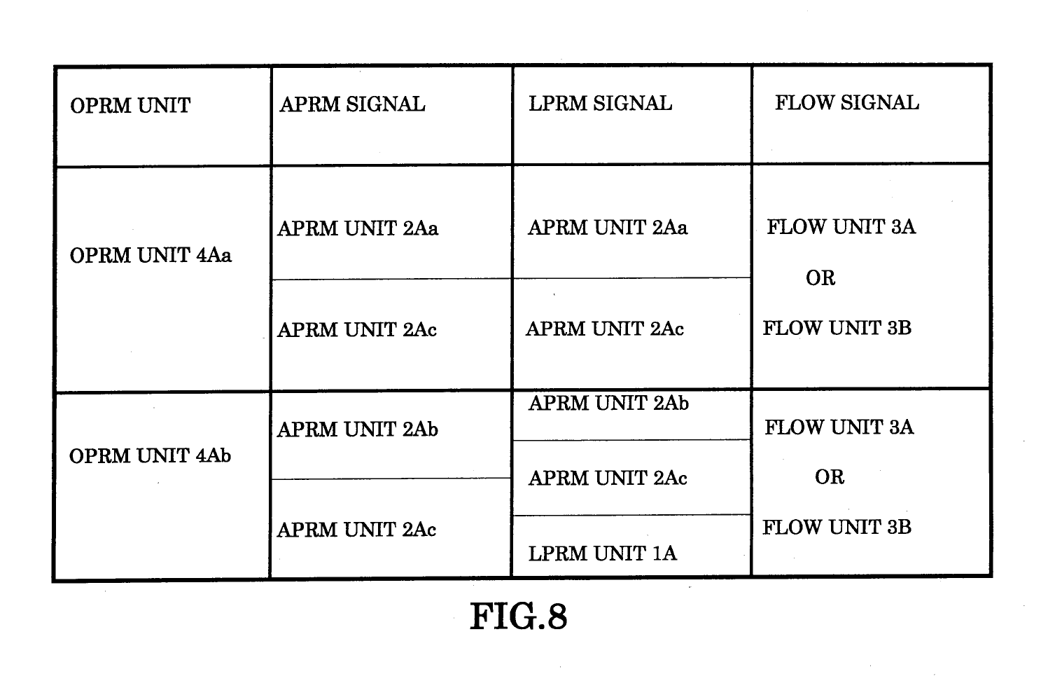

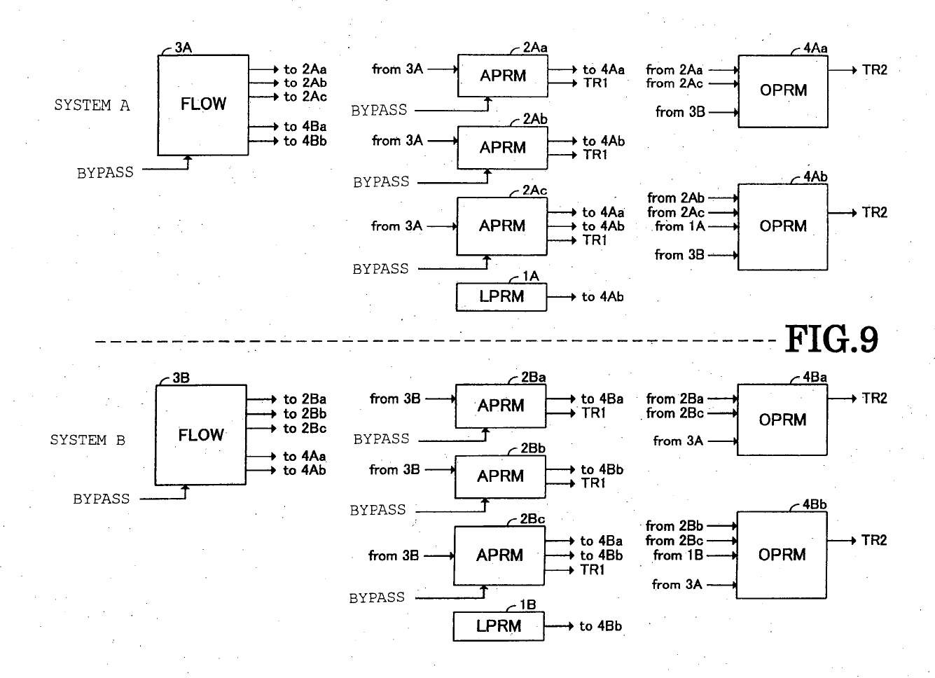

FIG. 8 is a block diagram showing the diagrammatic layout of a power monitoring system for a reactor according to a fourth embodiment. FIG. 9 is a view showing the sources of supply for the signals supplied to the various OPRM units. Hereinafter, the description will focus on the differences with regard to the second and third embodiments.

The FLOW units 3A, 3B supply FLOW signals and diagnostic information to six APRM units 2Aa to 2Ac and 2Ba to 2Bc.

If both of the items of diagnostic information associated with the two received FLOW signals indicate normality, the APRM unit 2Aa supplies to the OPRM unit 4Aa the FLOW signal, of the two FLOW signals, that has the smaller value.

In contrast, if one of the items of diagnostic information associated with the two received FLOW signals indicates abnormality, the APRM unit 2Aa supplies to the OPRM unit 4Aa the FLOW signal that was supplied from the FLOW unit that indicated normality.

It should be noted that, in the case where neither of the items of diagnostic information associated with the two received FLOW signals indicates normality, the APRM unit 2Aa supplies to the OPRM unit 4Aa a message to the effect that the reactor coolant flow rate cannot be determined.

The processing action of the other APRM units 2Ab, 2Ac, 2Ba to 2Bc is substantially the same as that of the APRM unit 2Aa, apart from the destination of signal supply. It should be noted that it is desirable to employ optical fiber cable for electrically isolating the system A and the system B when transmitting the FLOW signals from the system A to the system B or from the system B to the system A.

Just as in the case of the other embodiments, the OPRM unit generates the second trip signal TR2 based on an APRM signal, LPRM signal and FLOW signal. Also, if it receives information to the effect that the reactor coolant flow rate cannot be determined, the OPRM unit generates the second trip signal TR2.

Thus, in this fourth embodiment, just as in the first embodiment, even if one of the APRM units or one of the FLOW units is not operating normally, the OPRM functionality is maintained and the trip signal is generated in an appropriate manner. Also, just as in the case of the third embodiment, in a power monitoring system in which only one FLOW unit is provided in each system, even if the FLOW unit is not functioning normally in only one system, the OPRM functionality is maintained and a trip signal is generated in appropriate fashion, by utilizing the FLOW unit of the other system. Furthermore, in the fourth embodiment, the FLOW signal is shared by the OPRM unit and APRM unit by supplying the FLOW signal from the FLOW unit through the APRM unit to the OPRM unit. There is therefore no need to increase communication links between the FLOW unit and the OPRM unit, so the number of wirings can be reduced, simplifying the hardware construction.

### Fifth Embodiment

In the fifth embodiment described below, within the same system, the FLOW signal is supplied from the FLOW unit to the OPRM unit through the APRM unit, whereas, in the other system, the FLOW signal is supplied directly from the FLOW unit to the OPRM unit.

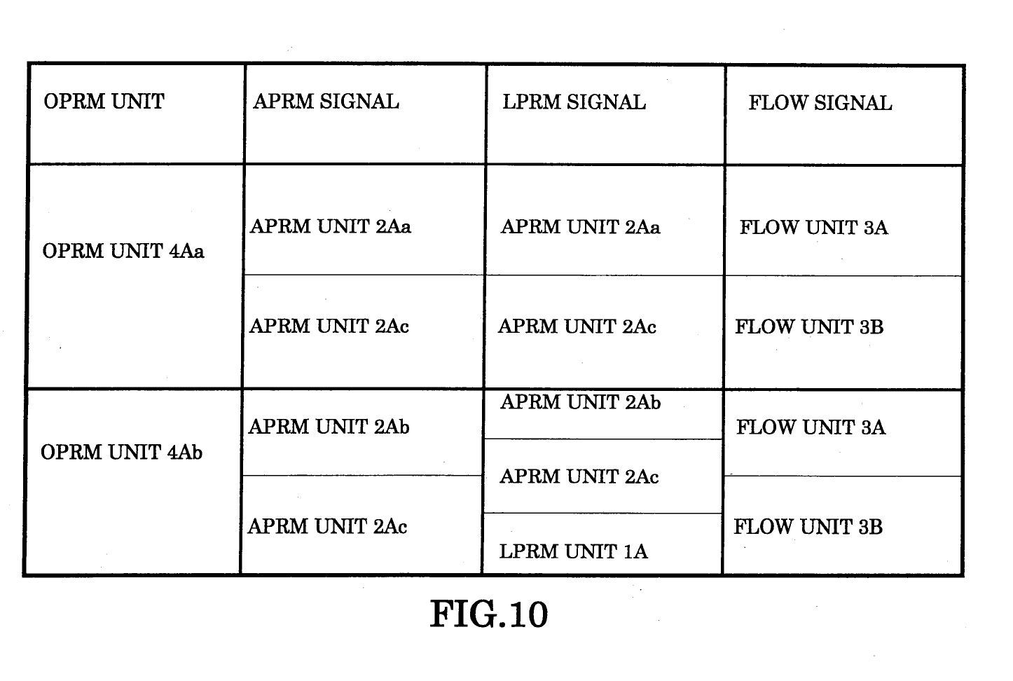

FIG. 9 is a block diagram showing the diagrammatic layout of a power monitoring system for a reactor according to a fifth embodiment. Also, FIG. 10 is a view showing the source of supply of the signals that are supplied to each OPRM unit. Hereinafter, the description will focus on the differences with regard to the third and fourth embodiments.

The FLOW unit 3A supplies a FLOW signal and diagnostic information to the three APRM units 2Aa to 2Ac in system A and supplies a FLOW signal and diagnostic information to the two OPRM units 4Ba, 4Bb within the system B. Also, the FLOW unit 3B supplies a FLOW signal to the three APRM units 2Ba to 2Bc in system B and supplies a FLOW signal to the two OPRM units 4Aa, 4Ab within the system A.

If the diagnostic information that is associated with the received FLOW signal indicates normality, the APRM unit 2Aa supplies a FLOW signal to the OPRM unit 4Aa. On the other hand, if the diagnostic information associated with the received FLOW signal indicates abnormality, the APRM unit 2Aa supplies a message to the effect that the reactor coolant flow rate cannot be determined to the OPRM unit 4Aa.

Apart from the fact that the supply destination of the signal from the APRM unit 2Ab is the OPRM unit 4Ab and that the supply destination of the signal from the APRM unit 2Ac is the OPRM units 4Aa, 4Ab, the processing action of the APRM units 2Ab, 2Ac is the same as that of the APRM unit 2Aa.

The OPRM unit 4Aa receives a FLOW signal from the FLOW unit 3A of system A through the APRM units 2Aa, 2Ac and receives a FLOW signal and diagnostic information directly from the FLOW unit 3B of the system B. Also, the OPRM unit 4Aa receives an APRM signal and diagnostic information from the APRM units 2Aa, 2Ac.

Of the FLOW signals supplied from an APRM unit or FLOW unit whose diagnostic information indicates normality, the OPRM unit 4Aa determines whether or not the reactor coolant flow rate is low using the FLOW signal whose value is smallest. Also, in the case where all of the items of diagnostic information indicate abnormality or in which the reactor coolant flow rate cannot be determined, for safety reasons, the OPRM unit 4Aa generates the second trip signal TR2 and transmits this to the RPS.

The same applies to the OPRM unit 4Ab.

Thus, just as in the case of the first embodiment, in this fifth embodiment, even if one of the APRM units or one of the FLOW units is not operating normally, the OPRM functionality is maintained and a trip signal can be generated in an appropriate fashion. Also, just as in the case of the third embodiment, in a power monitoring system in which only one FLOW unit is provided in each system, even in the case where the FLOW unit in one system is not operating normally, the OPRM functionality is maintained by utilizing the FLOW unit of the other system, making it possible to generate a trip signal in an appropriate fashion. Furthermore, in the fifth embodiment, since a FLOW signal is supplied in the same system from the FLOW unit to an OPRM unit through an APRM unit, and, in the other system, the FLOW signal is supplied directly from the FLOW unit to the OPRM unit, the number of communication links can be further reduced, making it possible to reduce the number of wirings and so simplify the hardware construction.

It should be noted that the constructions of the power monitoring system described above are merely examples. For example, the numbers of the LPRM units, the APRM units, FLOW units and OPRM units could be suitably altered and the LPRM units could be dispensed with, employing only LPRM signals generated by the APRM units.

While various embodiments of the present invention have been described, these embodiments are presented merely by way of example and are not intended to restrict the scope of the invention. These embodiments could be put into practice in various other modes, and various deletions, substitutions or alterations could be made without departing from the gist of the invention. These embodiments or modifications are included in the scope or gist of the invention and, likewise, are included in the scope of the invention set out in the patent claims and the scope of equivalents thereof.

What is claimed is:

1. A power monitoring system for a nuclear reactor, having at least a first system and second system, the first system and the second system respectively comprising:
a plurality of APRM units;
a plurality of FLOW units; and
a plurality of OPRM units;
wherein:
the APRM units respectively generate an LPRM signal that indicates an local output of neutrons by a reactor core, and generate an APRM signal indicating an average output of the reactor core, based on the LPRM signal;
the FLOW units respectively generate a FLOW signal indicating a flow rate of reactor coolant; and
the OPRM units respectively are supplied with LPRM signals and APRM signals from at least two the APRM units and are supplied with the FLOW signal from at least one the FLOW unit, and, based on supplied LPRM signals, APRM signals and FLOW signals, decide whether or not a trip signal for shutting down a reactor is to be generated and, if they decide that such the signal is to be generated, generate the trip signal.

2. The power monitoring system for a nuclear reactor according to claim 1,
wherein the OPRM units are respectively supplied with the FLOW signals from at least two the FLOW units.

3. The power monitoring system for a nuclear reactor according to claim 1,
wherein the APRM units are respectively supplied with the FLOW signal from at least two the FLOW units and one of the supplied FLOW signals is supplied to the OPRM units.

4. The power monitoring system for a nuclear reactor according to claim 3,
wherein if all of the FLOW units that are sources of supply of the APRM units are abnormal, the APRM units respectively supply to the OPRM units information to the effect that determination of a reactor coolant flow rate is impossible; and
if one or more of the FLOW units that are the sources of supply is normal, supply to the OPRM units the FLOW signal of smallest value of the FLOW signals.

5. A power monitoring system for a nuclear reactor, having at least a first system and second system, the first system and the second system respectively comprising:
a plurality of APRM units;
at least one FLOW unit; and
a plurality of OPRM units;
wherein:
the APRM units respectively generate an LPRM signal that indicates a local output of neutrons by a reactor core, and generate an APRM signal indicating an average output of the reactor core, based on the LPRM signal;
the FLOW units respectively generate a FLOW signal indicating a flow rate of reactor coolant; and
the OPRM units respectively are supplied with LPRM signals and APRM signals from at least two the APRM units in a same system and are supplied with the FLOW signal from at least one of the FLOW unit in the same system and the FLOW unit in another system; and, based on supplied LPRM signals, APRM signals and FLOW signals, decide whether or not a trip signal for shutting down the reactor is to be generated and, if they decide that such the signal is to be generated, generate the trip signal.

6. The power monitoring system for a nuclear reactor according to claim 5,
wherein the APRM units are respectively supplied with the FLOW signals from at least one the FLOW unit in the same system and at least one the FLOW unit in the another system, and one of the supplied FLOW signals is supplied to the OPRM units.

7. The power monitoring system for a nuclear reactor according to claim 6,
wherein if all of the FLOW units that are the sources of supply of the APRM units are abnormal, the APRM units respectively supply to the OPRM units information to the effect that determination of the reactor coolant flow rate is impossible; and
if one or more of the FLOW units that are the sources of supply is normal, supply to the OPRM units the FLOW signal of smallest value of the FLOW signals.

8. The power monitoring system for a nuclear reactor according to claim 5,
wherein the FLOW units supply the FLOW signals respectively to the APRM units in the same system and supply the FLOW signals to the OPRM units in the another system without passing through the APRM units; and
the APRM units respectively supply the supplied FLOW signals to the OPRM units in the same system respectively.

9. The power monitoring system for a nuclear reactor according to claim 1,
wherein the APRM units determine whether or not to generate the trip signal based on the APRM signal that is supplied from the APRM unit that is normal, of at least two supplied the APRM signals.

10. The power monitoring system for a nuclear reactor according to claim 9,
wherein the APRM units respectively generate first diagnostic information indicating whether or not the APRM unit in question is itself normal, together with the APRM signal, and
the OPRM units determine whether or not the APRM unit that is the source of supply of the APRM signal is normal, based on the first diagnostic information.

11. The power monitoring system for a nuclear reactor according to claim 9,
wherein, when the OPRM unit is supplied with the APRM signals from the APRM units, two or more of which are normal, the OPRM unit determines whether or not to generate the trip signal based on the APRM signal whose value is largest.

12. The power monitoring system for a nuclear reactor according to claim 1,
wherein, when the OPRM units is supplied with at least two the FLOW signals, the OPRM unit determines whether or not to generate the trip signal based on a FLOW signal supplied from the FLOW unit which is normal.

13. The power monitoring system for a nuclear reactor according to claim 12,
wherein the FLOW units respectively generate second diagnostic information indicating whether or not the FLOW unit in question is itself normal, together with the FLOW signal, and
the OPRM unit determines whether or not the FLOW unit that is the source of supply of the FLOW signal is normal, based on the second diagnostic information.

14. The power monitoring system for a nuclear reactor according to claim 12,
wherein the OPRM unit, if the FLOW signal is supplied from two or more the FLOW units that are normal, determines whether or not to generate the trip signal, based on the FLOW signal of smallest value.

15. The power monitoring system for a nuclear reactor according to claim 1,
wherein at least some of the APRM signals, the LPRM signals and the FLOW signals are transmitted between the units as optical signals.
